(19) United States
(12) Patent Application Publication
(10) Pub. No.: US 2026/0307182 A1
(43) Pub. Date: Oct. 8, 2026

(54) MOUNTING PIN HOLDERS USING A LASER WELDING PROCESS

(71) Applicants: STMicroelectronics International N.V., Geneva (CH); SHENZHEN STS MICROELECTRONICS CO., LTD., Shenzhen (CN)

(72) Inventors: Hein Fatt NG, Singapore (SG); Lin LIANG, Shenzhen (CN); Jiangnan HU, Shenzhen (CN); Enghsiung NG, Balestier (SG)

(73) Assignees: STMicroelectronics International N.V., Geneva (CH); SHENZHEN STS MICROELECTRONICS CO., LTD., Shenzhen (CN)

(21) Appl. No.: 19/556,445

(22) Filed: Mar. 4, 2026

Related U.S. Application Data
(60) Provisional application No. 63/782,290, filed on Apr. 2, 2025.

(51) Int. Cl. B23K 37/04; B23K 26/28; B23K 101/42; B23K 103/12

(52) U.S. Cl. CPC B23K 37/0426; B23K 26/28; B23K 2101/42; B23K 2103/12

(57) ABSTRACT

A substrate includes a copper trace. A copper pin holder has a hollow cylindrical member with a flange member. The flange member of the copper pin holder is held in contact with the copper trace. A laser beam is then applied to an upper surface of the flange member to form at least one direct copper-to-copper tack weld between the flange member of the pin holder and the copper trace. The hold on the copper pin holder is then released. The laser beam is then again applied to the upper surface of the flange member at a starting position and the applied laser beam is moved along a circumferential trace path about a perimeter of the hollow cylindrical member of the pin holder to form a direct copper-to-copper weld between the flange member of the pin holder and the copper trace.

### CROSS REFERENCE TO RELATED APPLICATIONS

This application claims priority from United States Provisional Application for Patent No. 63/782,290, filed Apr. 2, 2025, the content of which is incorporated herein by reference.

### TECHNICAL FIELD

The present disclosure generally relates to a process for mounting a pin holder to a substrate through a direct copper-to-copper bond formed using laser welding.

### BACKGROUND

Many circuit device applications require the use of a pin holder which must be mounted to an underlying substrate. Such a substrate may comprise an active metal brazing (AMB) technology ceramic substrate well-suited for use in electronic devices that require high voltage/current conductivity and good thermal/mechanical stability. A copper-based material layer is applied to a ceramic substrate surface, which is then heated to a high temperature in the presence of a reducing gas atmosphere. This causes the copper-based material to react with the ceramic and form a strong chemical bond, allowing the metal layer to be joined to the ceramic substrate. The copper layer may then be coated with a silver layer.

To mount a pin holder to the ceramic substrate in a conventional process, the pin holder is positioned at a desired location on the substrate, for example using a pick and place process machine, and attached thereto using a solder sintering process. This conventional process for pin holder mounting has a number of drawbacks including, without limitation: sintering with solder paste requires the presence of the silver layer adding additional cost and processing time; the formed joint must be cured in a reflow oven; flux cleaning after solder cure is needed; an automated optical inspection is required to ensure accuracy of the joint. Additionally, joint strength is highly dependent and limited by the material used, the applied mechanical stress and the heat applied.

There is a need in the art for a simpler pin holder mounting process which possesses space and cost savings in conjunction with process and quality improvement in comparison to the conventional solder sintering process.

### SUMMARY

In an embodiment, a method comprises: holding a copper pin holder in contact with a copper trace on a substrate, said copper pin holder having a hollow cylindrical member with a flange member, wherein the flange member contacts the copper trace; applying a laser beam to an upper surface of the flange member to form at least one direct copper-to-copper tack weld between the flange member of the pin holder and the copper trace; releasing hold on the copper pin holder which is attached to the copper trace by the at least one direct copper-to-copper tack weld; and applying the laser beam to the upper surface of the flange member at a starting position and moving the applied laser beam along a circumferential trace path about a perimeter of the hollow cylindrical member of the pin holder to form a direct copper-to-copper weld between the flange member of the pin holder and the copper trace.

In an embodiment, a device comprises: a substrate having a copper trace; a copper pin holder on the copper trace, said copper pin holder having a hollow cylindrical member with a flange member, wherein the flange member contacts the copper trace; and a direct copper-to-copper weld between the flange member of the pin holder and the copper trace, said direct copper-to-copper weld following a circumferential trace path about a perimeter of the hollow cylindrical member of the pin holder.

The direct copper-to-copper weld encompasses at least one direct copper-to-copper tack weld between the flange member of the pin holder and the copper trace.

### BRIEF DESCRIPTION OF THE DRAWINGS

For a better understanding of the embodiments, reference will now be made by way of example only to the accompanying figures in which:

FIG. 1 is a perspective view of a pin holder mounted to an underlying substrate;

FIG. 2 is a cross-sectional scanning electron micrograph (SEM) image of the pin holder mounted to the substrate by laser welding forming a direct copper-to-copper bond;

FIGS. 3A-3L show steps in a process for laser welding the pin holder to the substrate; and

FIG. 4 is a photographic image showing a perspective view of a circuit device including a plurality of pin holders that have been laser welded to a substrate using the method of FIGS. 3A-3L.

### DETAILED DESCRIPTION

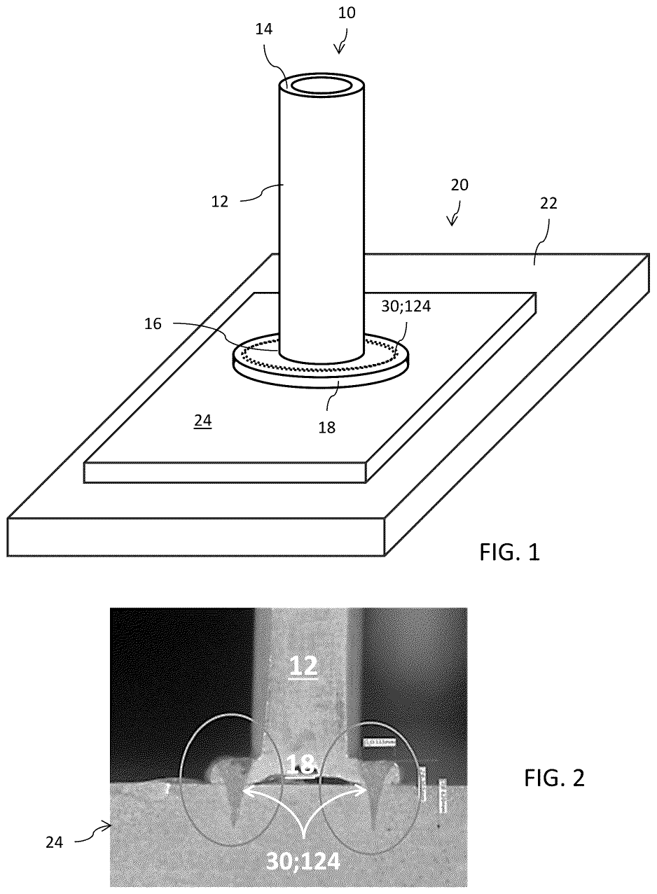

Reference is now made to FIG. 1 which shows is a perspective view of a pin holder 10 mounted to an underlying substrate 20. The pin holder 10 comprises a hollow cylindrical member 12 having a first end 14 and a second end 16 and a flange member 18 at the second end 16. The pin holder 10 is made of a copper-based material. The substrate 20 is, for example, an active metal brazing (AMB) technology ceramic substrate including a ceramic substrate portion 22 and a copper-based material trace 24. Notably, and advantageously from a cost and processing time perspective, there is no silver layer present on the upper surface of the copper-based material trace 24. The attachment of the pin holder 10 to the substrate 20 is made by a direct copper-to-copper bond formed using a laser welding process. The bond location is generally indicated in a schematic way in FIG. 1 at reference 30 (also referred to herein as weld 124) which shows the location of the laser path trace which forms the weld. The bond is made between the flange member 18 of the pin holder 10 and the copper-based material trace 24 circumferentially around the second end 16 of the hollow cylindrical member 12.

For reference purposes, example dimensions for the pin holder 10 comprise: total height 2.8 mm; flange member diameter 2.2 mm; flange member thickness 0.4 mm; cylindrical member outer diameter 1.0 mm; cylindrical member inner diameter 0.70 mm. It will be understood, however, that pin holders 10 having different dimensions can be used depending on circuit or device application.

While an implementation for bonding to an AMB technology ceramic substrate is shown, it will be understood that bonding of the pin holders to other copper-based material substrates is within the scope of the invention.

FIG. 2 shows a cross-sectional image of the pin holder 10 mounted to the copper-based material trace 24 of the substrate 20 by direct copper-to-copper bonding formed by laser welding. The laser welded bonds at the flange member 18 are generally indicated at reference 30 within the oval-shaped regions for the weld 124.

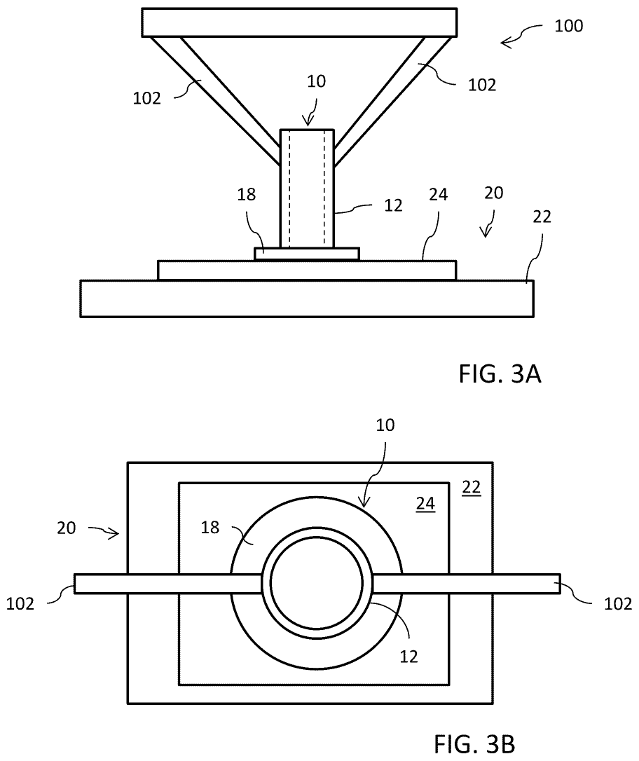

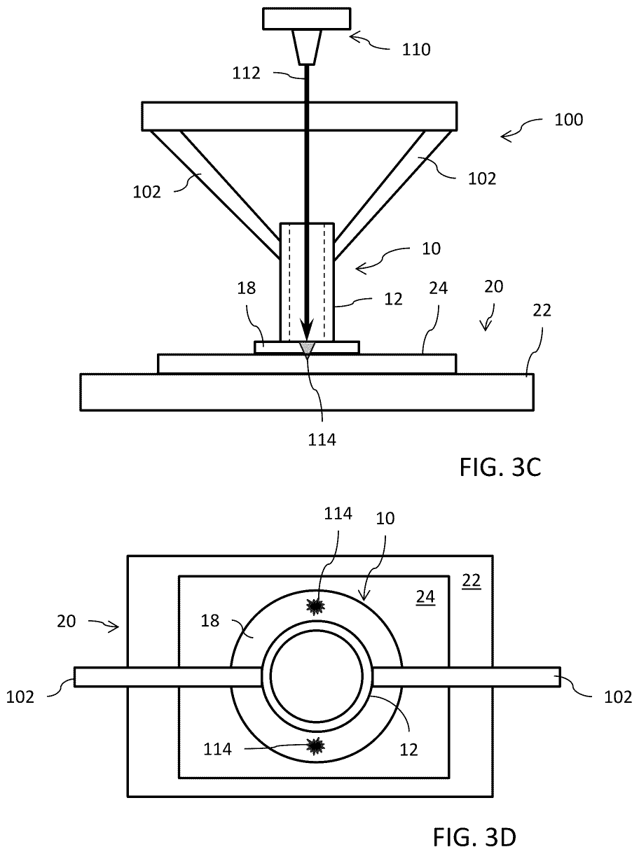

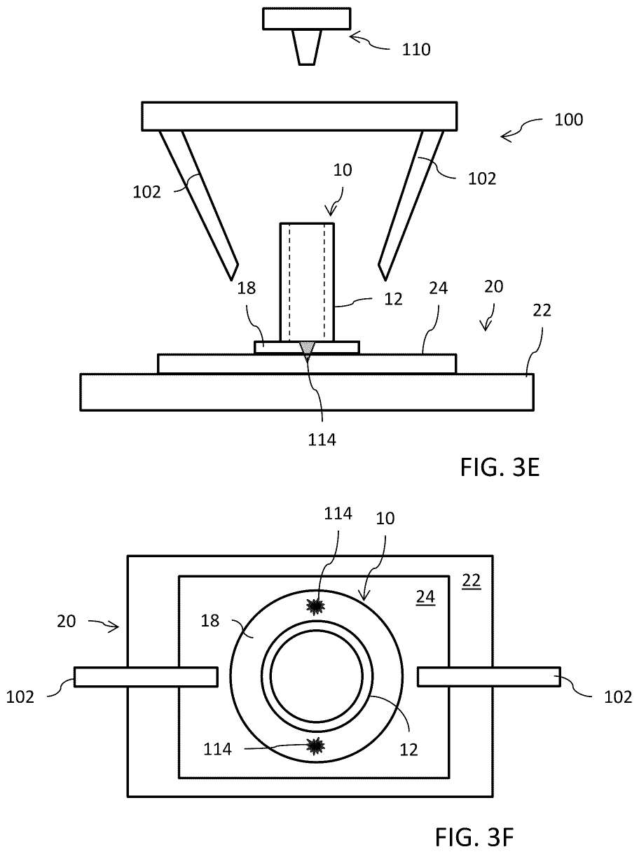

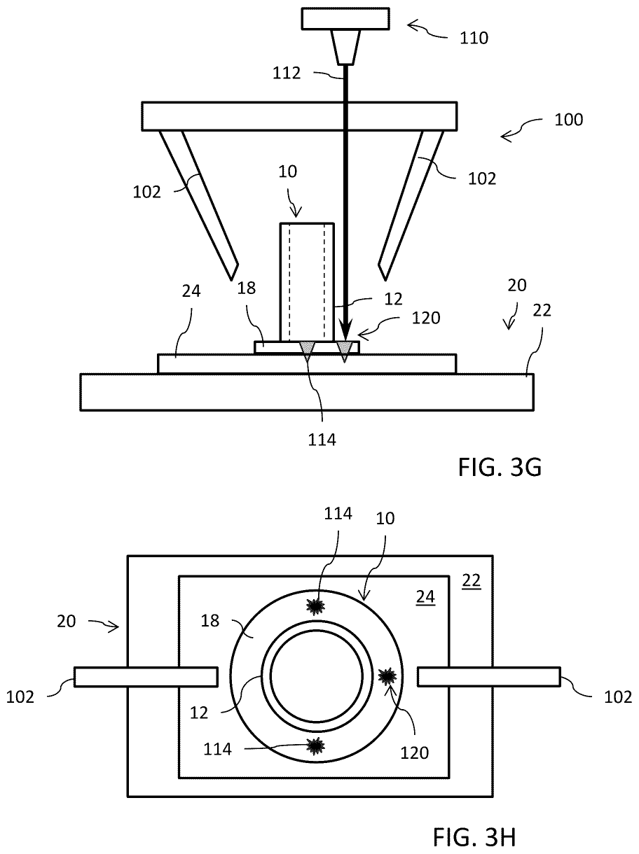

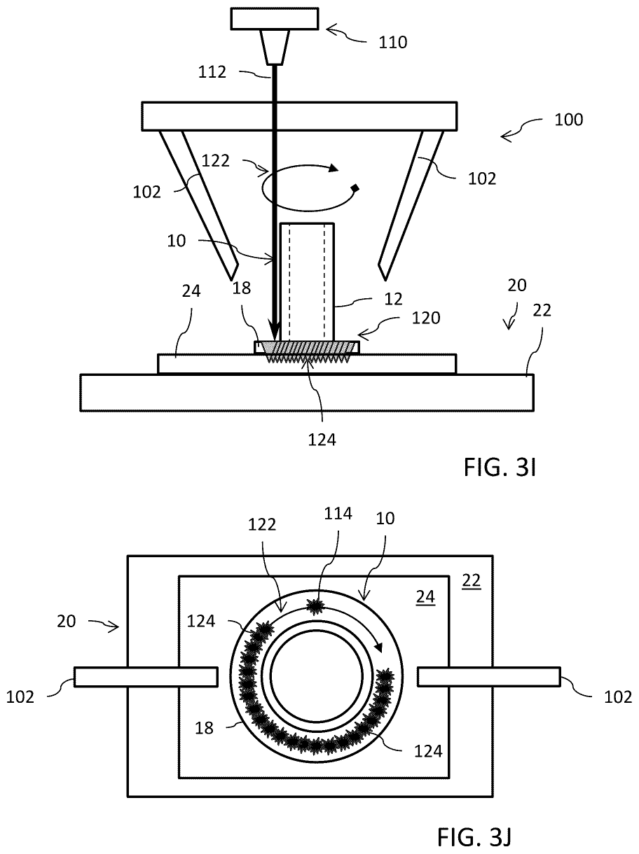

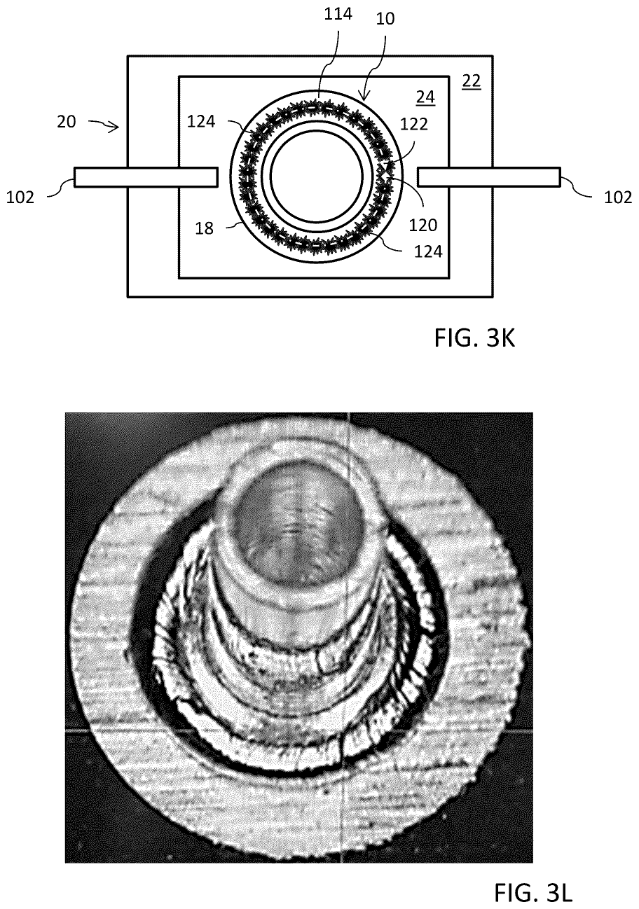

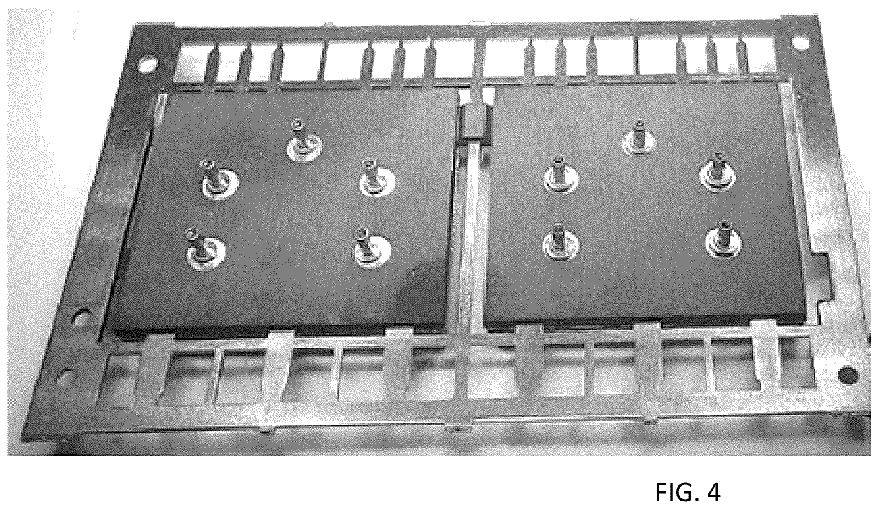

Reference is now made to FIGS. 3A-3L which show steps in a process for laser welding the pin holder 10 to the substrate 20.

FIG. 3A—a pick and place machine 100 places the pin holder 10 at a desired location on the substrate 20. Specifically, the hollow cylindrical member 12 of the pin holder 10 is engaged by clamp members 102 of the pick and place machine 100 and the flange member 18 of the pin holder 10 is placed and held in contact with the upper surface of the copper-based material trace 24 of the substrate 20 at the desired mounting location.

FIG. 3B—shows a top view of FIG. 3A.

FIG. 3C—with the pick and place machine 100 holding the pin holder 10 at the desired location on the substrate 20, a laser welding machine 110 applies a laser beam 112 at two or more selected discrete locations on the upper surface of the flange member 18 to provide direct copper-to-copper tack welds (i.e., pre-welds) 114 between the flange member 18 and the copper-based material trace 24. The weld depth may, for example, be about 50% of the total thickness of the copper-based material trace 24 (as a non-limiting example, for a flange 18 thickness of 0.4 mm and a copper-based material trace 24 thickness of 0.8 mm, the weld depth passes completely through the flange and to a depth of about 0.4 mm in the copper-based material trace; see, cross-section of FIG. 2). The laser welding machine 110 may, for example, comprise a fiber laser from IPG Photonics which includes a robotic positioning and movement system. The fiber laser may have a power of about 4 kW, a beam size of 50 μm, and a red beam pulsed at 1064 Hz to accomplish the direct copper-to-copper welding. Operation of the laser can be optimized to achieve rapid weld penetration in forming the tack welds 114. Through operation parameter setting, device configuration and programmed movement, the location, depth, width and length of the laser welding and penetration can be controlled.

FIG. 3D—shows a top view of FIG. 3C with two tack welds 114 in place. The tack welds 114 may be equally circumferentially spaced apart from each other as desired (with the 180° spacing shown for two such welds being just an example—and it being understood that three, four or more tack welds may be used in some cases).

FIG. 3E—the clamp members 102 of the pick and place machine 100 then release their hold on the pin holder 10. The use of a pre-weld cycle in FIG. 3C for providing two or more tack welds 114 effectively secures the pin holder 10 at the desired location on the substrate 20 when the gripping pressure of the clamp members 102 for the pick and place machine 100 is released. This pre-weld cycle ensures that the desired positioning of the pin holder 10 will not be disturbed by the subsequently performed full-weld cycle.

FIG. 3F—shows a top view of FIG. 3E.

FIG. 3G—the laser welding machine 110 then applies the laser beam 112 to the upper surface of the flange member 18 during a full-weld cycle, starting at a position 120 circumferentially offset from the location of the previously made tack welds 114.

FIG. 3H—shows a top view of FIG. 3G. Here, the starting position 120 is shown, by example only, to be equally circumferentially spaced away from the two circumferentially adjacent tack welds 114.

FIG. 3I—the laser welding machine 110 then moves the applied laser beam 112 in a clockwise or counterclockwise direction along a circumferential trace path (indicated by arrow 122) about the perimeter of the hollow cylindrical member 12 of the pin holder 10 to form a direct copper-to-copper weld 124 of the pin holder 10 to the copper-based material trace 24. The weld depth may, for example, be about 50% of the total thickness of the copper-based material trace 24 (as a non-limiting example, for a flange 18 thickness of 0.4 mm and a copper-based material trace 24 thickness of 0.8 mm, the weld depth passes completely through the flange and to a depth of about 0.4 mm in the copper-based material trace; see, cross-section of FIG. 2). Here again, the laser welding machine 110 may, for example, comprise a fiber laser from IPG Photonics which includes a robotic positioning and movement system. The fiber laser may have a power of about 4 kW, a beam size of 50 μm, and a red beam pulsed at 1064 Hz to accomplish the direct copper-to-copper welding. Operation of the laser can be optimized to achieve rapid weld penetration and scanned along any desired trace path 122 in forming the weld 124. Through operation parameter setting, device configuration and programmed movement, the location, depth, width and length of the laser welding and penetration can be controlled. In a preferred implementation, the formed weld is continuous along the circumferential trace path 122 and completely around the perimeter of the hollow cylindrical member 12 of the pin holder 10 (but it will be noted that discontinuous weld segments along the circumferential trace path 122 around the perimeter of the hollow cylindrical member 12 could instead be used).

FIGS. 3J and 3K—show a top view of FIG. 3I. FIG. 3J illustrates completion of about 230° of laser welding along the full 360° circumferential trace path 122. FIG. 3K illustrates full completion of laser welding for the full-weld cycle to form the weld 124 over at least the 360° circumferential trace path.

FIG. 3L—shows a photograph of the pin holder 10 with the flange member 18 mounted by the direct copper-to-copper circumferential weld 124 to the copper-based material trace 24 of the substrate 20.

As alternatives, the movement of the laser beam 112 applied by the laser welding machine 110 along the circumferential trace path 122 during the full-weld cycle can exceed 360°. For example, completion of the laser welding process in the full-weld cycle may include application of the circumferentially moving laser beam 112 to include an additional overlap of 20° to 40° (i.e., tracing the path 122 over 380° to 400°). Still further additional overlap may be useful as well: for example, over a range from 500° to 600° (one and on-half times around); or over a range from 720° to 800° (two or more times around).

Use of laser welding for mounting pin holders provides a number of advantages over prior mounting solutions including: stronger interconnect; deeper penetration of interconnect; independent control over pattern, area, depth; better speed: improved cycle time/fast welding time; more cost effective: replaces multiple processes, simplifies process steps; better precision can achieve higher pin holder accuracy control; improved consistency and reliability in the process; higher versatility: reduced material (plating), machine and tooling cost; better flexibility to weld different metals; does not require any solvents or additives, no chemical cleaning required; better reliability: improves fatigues due to coefficient of thermal expansion (CTE) at joint and increases reliability with higher current/voltage limits; can support the welding of thicker materials (dependent on the laser system).

Advantageously, especially in comparison with prior sintering with solder paste processing, the use of laser welding for direct copper-to-copper bonding: does not require use of additional bonding materials (like a silver plated layer or paste application at the joint); welds the two raw materials (copper and copper in the example) together to form a strong intermetallic welding that can withstand high stress and heat; and does not require a curing or cleaning process.

With the use of laser welding for direct copper-to-copper bonding, the mounting process: reduces the required process steps; does not require screen printing (thus obviating stencil design and cost as well a change for accommodating different products); does not require a plating layer for supporting adhesion; does not require flux cleaning and reflow; does not require automated optical inspection for process control; minimizes machine/maintenance/tooling cost and floor space; is not subject to concerns with potential void presence, pin holder shifting or flange delamination as a result of reflow; provides improved joint strength with less sensitivity to temperature; removes concerns with CTE mismatch inducing fatigue or adversely affecting product reliability; and supports a direct material interconnection for a strong joint.

While the invention has been illustrated and described in detail in the drawings and foregoing description, such illustration and description are considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

What is claimed is:

1. A method, comprising:
holding a copper pin holder in contact with a copper trace on a substrate, said copper pin holder having a hollow cylindrical member with a flange member, wherein the flange member contacts the copper trace;
applying a laser beam to an upper surface of the flange member to form at least one direct copper-to-copper tack weld between the flange member of the pin holder and the copper trace;
releasing hold on the copper pin holder which is attached to the copper trace by the at least one direct copper-to-copper tack weld; and
applying the laser beam to the upper surface of the flange member at a starting position and moving the applied laser beam along a circumferential trace path about a perimeter of the hollow cylindrical member of the pin holder to form a direct copper-to-copper weld between the flange member of the pin holder and the copper trace.

2. The method of claim 1, wherein the starting position is circumferentially offset from a location of the at least one direct copper-to-copper tack weld.

3. The method of claim 1, wherein the direct copper-to-copper weld follows the circumferential trace path over at least 360°.

4. The method of claim 1, wherein the direct copper-to-copper weld follows the circumferential trace path over at least 400°.

5. The method of claim 1, wherein the direct copper-to-copper weld follows the circumferential trace path over at least 500°.

6. The method of claim 1, wherein the direct copper-to-copper weld follows the circumferential trace path over at least 720°.

7. The method of claim 1, wherein the direct copper-to-copper weld is continuous along the circumferential trace path.

8. The method of claim 1, wherein applying the laser beam to form at least one direct copper-to-copper tack weld comprises forming at least two circumferentially spaced-apart direct copper-to-copper tack welds.

9. The method of claim 8, wherein the at least two circumferentially spaced-apart direct copper-to-copper tack welds are equally circumferentially spaced-apart.

10. The method of claim 9, wherein the starting position is circumferentially equally spaced between adjacent ones of the at least two circumferentially spaced-apart direct copper-to-copper tack welds.

11. A device, comprising:
a substrate having a copper trace;
a copper pin holder on the copper trace, said copper pin holder having a hollow cylindrical member with a flange member, wherein the flange member contacts the copper trace; and
a direct copper-to-copper weld between the flange member of the pin holder and the copper trace, said direct copper-to-copper weld following a circumferential trace path about a perimeter of the hollow cylindrical member of the pin holder.

12. The device of claim 11, wherein the direct copper-to-copper weld follows the circumferential trace path over at least 360°.

13. The device of claim 11, wherein the direct copper-to-copper weld follows the circumferential trace path over at least 400°.

14. The device of claim 11, wherein the direct copper-to-copper weld follows the circumferential trace path over at least 500°.

15. The device of claim 11, wherein the direct copper-to-copper weld follows the circumferential trace path over at least 720°.

16. The device of claim 11, wherein the direct copper-to-copper weld is continuous along the circumferential trace path.

17. The device of claim 11, wherein the direct copper-to-copper weld encompasses at least one direct copper-to-copper tack weld between the flange member of the pin holder and the copper trace.
